(19) United States
(12) Patent Application Publication
(10) Pub. No.: US 2005/0197961 A1
(43) Pub. Date: Sep. 8, 2005

(54) Preference engine for generating predictions on entertainment products of services

(76) Inventors: Gregory P. Miller, Severna Park, MD (US); Michael R. Miller, Pompano Beach, FL (US)

Correspondence Address: JONES, TULLAR & COOPER, P.C., P.O. BOX 2266 EADS STATION, ARLINGTON, VA, 22202, US

(21) Appl. No.: 11/073,727

(22) Filed: Mar. 8, 2005

Related U.S. Application Data
(60) Provisional application No. 60/550,310, filed on Mar. 8, 2004.

(51) Int. Cl. H04K 1/00

(52) U.S. Cl. 705/52

(57) ABSTRACT

A preference predicting method compares a subject user's play list with a plurality of other user's play lists and generates suggested new entertainment product or service selections to the subject user. In an embodiment of the method, the user's play list is compared to stored play lists to identify, on a selection by selection basis, how many selection titles from the user are found on each of the stored play lists. This comparison step generates a peer comparison group of the stored play lists having at least a selected number (e.g., fifty) selection title matches. The peer comparison group entries having a selected number of the user's play list selection titles are identified as liking the same selections and each identified play list is searched to identify a selection title not included in the user's play list, thereby generating a predicted selection title for the subject user.

### RELATED APPLICATION INFORMATION AND PRIORITY CLAIM

This application claims priority to provisional patent application No. 60/550,310, filed Mar. 8, 2004, the entire disclosure of which is incorporated herein by reference.

### BACKGROUND OF THE INVENTION

1. Field of the Invention

The present invention relates to methods for predicting consumer choices and to automated methods for assisting a consumer in making a choice for an entertainment product or service from among a plurality of possible choices.

2. Discussion of the Prior Art

With the advent of digitally distributed music and other forms of entertainment and commerce, the use of consumer profiles or personal lists will become more prevalent. Portable computers, mp3 players, PDAs, networked vehicles, portable storage media, digital scanning devices and other digital appliances, provide consumers increasing access to a vast array of digital assets including digitally stored and transmitted entertainment products and services. The vast number of choices has overwhelmed some consumers and vendors have, in response, sought help to organize and manage musical and entertainment libraries, often by tracking their customer's purchasing history. For example, the Apple™ iTunes™ service includes a personal music management/player application enabling users to create and listen to playlists from their library of purchased digital music. Another web-based vendor, Amazon™ allows their customers to personalize their own new product recommendations and, by tracking past purchases, uses their web site to make additional product recommendations; for example, if a customer buys a first book on a topic, other titles on that topic are offered during the transaction.

The music distribution business is changing. Digital music distribution has become popular (e.g., through user-created entities such as Napster™) while the music industry has encountered growing difficulty in their cumbersome, expensive efforts to sell “multi-song records” through traditional retail channels. As a result, the music industry's artist and repertory (A&R) decision makers now must be extremely selective and must refuse to produce recordings for most artists, making it harder for artists to find an outlet for their creative efforts.

Consumers of recorded music are also frustrated by what appears to be a shrinking number of choices. At live concerts, many new, exciting, original artists perform music that may defy categorization, and that music is often sold to fans only from the concert stage. Other fans wishing to buy those recordings find no opportunity to buy through traditional retail channels, and so the artist and the consumer both suffer.

There is a need, therefore, for a method to simplify a user's search for new music from the vast universe of possible choices. There is also a need for a mechanism or method permitting artists to make their new work available to consumers without requiring an artist to first engage in the traditional, cumbersome, expensive efforts to sell “multi-song records” through traditional retail channels.

### OBJECTS AND SUMMARY OF THE INVENTION

Accordingly, it is a primary object of the present invention to overcome the above-mentioned difficulties by providing a predictive method to simplify a user's search for new entertainment products or services (e.g., music) from the vast universe of possible choices.

Another object of the present invention is providing a mechanism or method permitting artists to make their new work available to consumers without requiring an artist to first engage in the traditional, cumbersome, expensive efforts to sell traditional commercial entertainment products or services (e.g., “multi-song records”) through traditional retail channels.

The aforesaid objects are achieved individually and in combination, and it is not intended that the present invention be construed as requiring two or more of the objects to be combined.

The method of the present invention includes a preference predicting engine or software driven method for generating predictions about a specific user's product or service preferences. In an exemplary embodiment, a user inputs a list of entertainment products such as music recordings, this list of recordings or songs is called a play list.

The method of the present invention may be characterized as an analytical predictor that musical “birds of a feather flock together.” The preference predicting engine compares the user's play list with a plurality of other user's play lists and runs them through a series of statistical filters that generate suggested new music selections to the user in question. The user may then decide to sample a segment of each suggested song or selection and make a purchasing decision by, for example, choosing to download the suggested selection for an agreed fee, such as one dollar per download.

In the exemplary embodiment or the method of the present invention, the user's play list includes a user selected number of (e.g., one hundred) selection titles and is imported to a database and is compared to a plurality of stored play lists, to identify, on a selection by selection basis, how many selection titles from the user are found on each of the stored play lists; this comparison step generates a peer comparison group of that subset of stored play lists having at least a selected minimum number (e.g., of selection title matches. The peer comparison group is ordered or ranked by number of selection title matches and a selected proportion of the peer comparison group having the highest proportion of selection title matches (e.g., those stored play lists having ninety percent or more of the user's play list selection titles, or having 90% matches) are identified as “ear-mates” meaning that the correlation suggests that the user and the profiled person for a selected ear-mate list like the same selections or songs.

Next, each ear-mate play list is searched to identify every selection title that is not included in the user's play list, thereby generating a peer's non-similar list. Next, the peer non-similar lists are compared to one another and the most frequently discovered peer non-similar list entry is selected as a best prediction selection title for the user. The peer's non-similar list is ordered or ranked by number of peer non-similar selection title matches. Next, a selected proportion of the peer non-similar list selection title matches having the highest proportion of title matches (e.g., those non-similar selection titles included on ninety percent or more of the ear-mate play lists) are identified as “Best Predictions.”

Optionally, the user can trim down the possible recommendations by providing additional selection criteria. For example, a user-selected output filter may be used to remove one or more of the Best Prediction song titles having one or more selected criteria (e.g., nothing performed by Madonna or nothing by the composer Wagner.) The preference engine session results may then be provided to the user in the form of a list of Best Prediction selection or song titles, whereupon a user may then select a song to sample from the list, listen to a sample segment, and then select one or more songs for download, preferably paying an agreed fee per download.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1 is a diagram illustrating the method of generating a user's control playlist, in accordance with the present invention.

FIG. 2 is a diagram illustrating the method of assembling a peer comparison group and generating a list of best predictions for entertainment products, in accordance with the present invention.

### DESCRIPTION OF THE PREFERRED EMBODIMENT

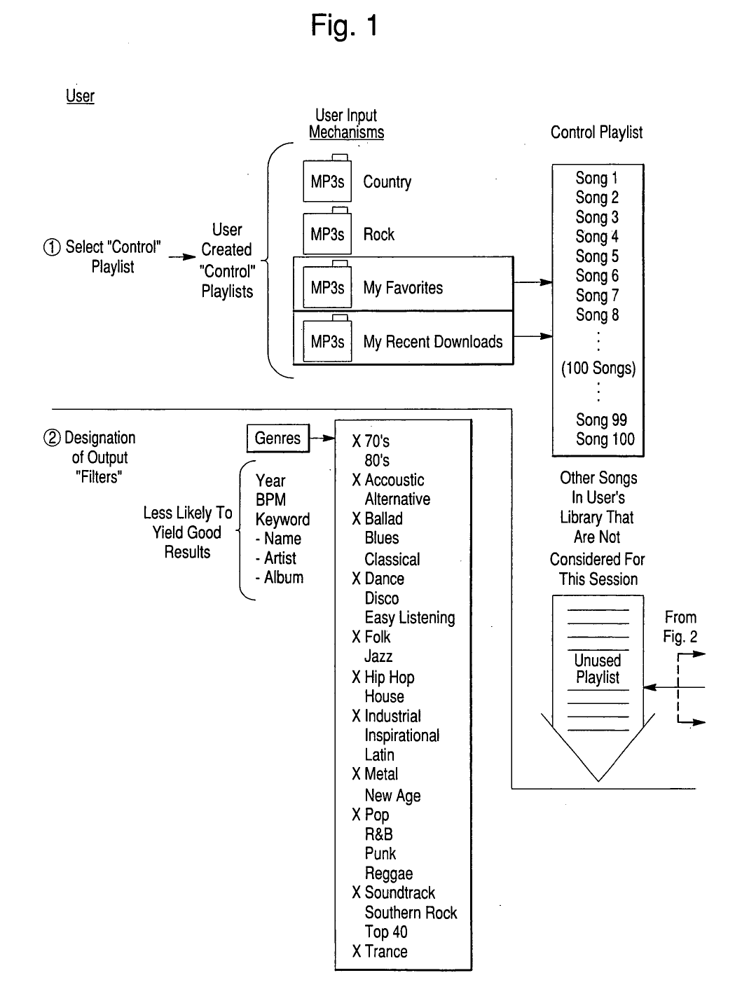

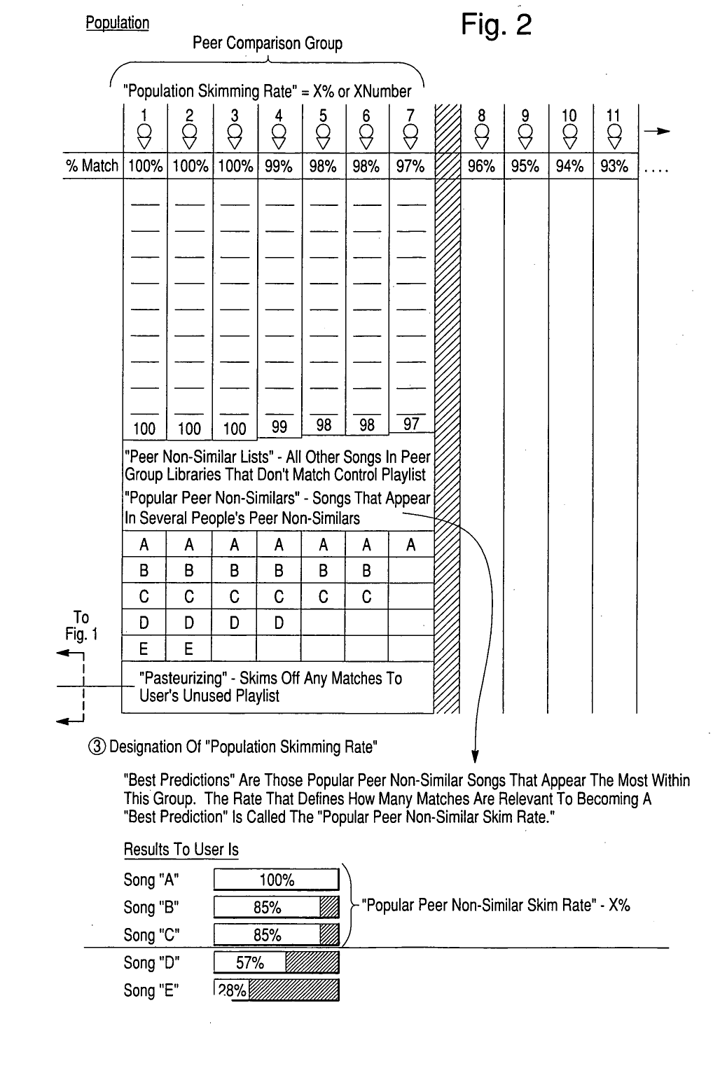

The preference engine and method of the present invention illustrated in FIGS. 1 and 2 provides a type of predictive analyzer. It is a system and method for suggesting and/or predicting preferences of entertainment products or services such as, for example, new alternative music titles. The system is based on collaborative profile analysis and popular deviations from user preference lists, play lists or product lists.

The system utilizes a database of people whose collective lists are compared and manipulated in as shown in the diagrams of FIGS. 1 and 2. By comparing the subject's list of items with lists from a multiple of other people, the system creates a collaborative analysis, which generates suggestions on products or services based on predictions of what a subject user will like.

With the advent of digitally distributed music and other forms of entertainment and commerce, the use of personal lists will become more prevalent. With the growth of portable computers, mp3 players, PDAs, networked vehicles, portable storage media, digital scanning devices and other digital appliances, people will have greater access to their digital assets and other personalized lists. These systems will help organize and manage consumers' musical and entertainment libraries, their purchasing preferences, etc. For example, as noted above, the Apple® iTunes® service is a personal music management/player application that enables users to create and listen to playlists from their library of purchased digital music.

As digital music distribution becomes more and more popular, the industry will be pressured to shift from selling “multi-song records” to selling “singles”—which, along with the growing accessibility of digital music, will create greater demand for more music. Because it will become harder for artists to produce enough popular singles for people to consume, it is anticipated that there will be an increased demand for music from a larger base of artists than exists currently in mainstream media. That will force consumers to seek alternative methods for finding new music and new artists beyond the existing “push model”—where forces in the music industry release artist's recordings on Compact Disc (CD) and push their music into the media—to a “pull model” where people will seek to find new music from the internet.

The system of the present invention is meant to simplify a user's search for new music by facilitating the collective recommendation of new songs from people who have demonstrated similar musical tastes via their similarity to the user's existing music library.

A first embodiment of the present invention includes six process steps:

First, select a statistically relevant peer group:

By looking for the most song matches between the subject User and a large plurality of other users in the System Population, the System selects a statistically relevant Peer Comparison Group—those are people who appear to have similar tastes to the user or “Ear-Mates” of the user (e.g., they like the same songs).

To assure that the system algorithm generates statistically relevant results, for each session, the algorithm performs a series of tests or Bracketing Algorithms with varying parameters (e.g., skim rates, weightings), taking into consideration both the user's entire Library (this is referred to as the subject user's Musical DNA) as well as the subject user's Control Playlist, as shown in FIG. 1. Through these tests, the system generates a series of results and applies an averaging algorithm to select the most statistically relevant Peer Comparison Group for the session, as shown in FIG. 2.

Second, Create Peers' Non-Similar Lists: These are the lists of the songs in the Peer Group that are not in the User's Library.

Third, Find the most popular songs among the Peers' Non-Similar Lists: Find the most frequently encountered or most popular songs in the Peers' Non-Similar Lists and designate them as Popular Peer Non-Similars. This step includes a Bracketing Algorithm to determine the right or optimal number of songs that are selected due to their statistical relevance.

Fourth, Create a Best Predictions List: Select the top percentage of Popular Peer Non-Similar songs. This step preferably also employs a Bracketing Algorithm to determine the right number of songs that are statistically relevant. Optionally, the user may select the number of songs or entertainment selections to be returned as recommendations.

Fifth, Apply any User-Designated Output Filters to the results: This involves filtering the resulting songs according to user-designated genres or those containing certain user-designated keywords in the information file.

Sixth, Provide Session Results: In this step a report is generated for the subject user identifying recommended entertainment products or services (e.g., songs) to the User.

A more detailed embodiment includes the following thirteen steps:

First, Compile System Population Records: The population includes other users whose product or service (e.g., song) libraries and playlists have been recorded in the system. Playlist recordation preferably occurs when the user submits their own request for new product or service (e.g., song) suggestions. The system can also be set up to accept “blind” song libraries that only designate an anonymous user to protect privacy. Or the song libraries may be tied to memberships or accounts to music stores, clubs, or other organizations, where the privacy is the responsibility of the business utilizing this method and system (e.g., Apple®, Sony®, etc.)

Second, assemble a user library for the subject user. In this step, all products or services in a given category (e.g., songs) owned by the user are identified. For this application, we can think of the subject user's collective library as his or her Musical DNA.

Third, the subject user defines a Control Playlist—A subject user will typically have his or her entire music library divided up into playlists. These common playlists are user-defined sub sets of their library used for organizing the music they own. The system enables the user to select one or several of his playlists or his entire library to be treated as his “Control Playlist” for use in a particular “session”. All songs that (a) appear in a User's Library but (b) are not in his Control Playlist make up the Unused Playlist.

Fourth, the System selects other users from the population to make up a Peer Comparison Group. The system compares the System Population's song libraries to the user's entire User Library and his Control Playlist to select a group of similar play lists provided by other people within the Population who represent the best “Ear-Mates” of the user. For example, people in the population who match the user's Control Playlist song for song, or match 100%, may not be statistically relevant if the Control Playlist contains only a handful (e.g., 3 or 4) songs. That's where finding people in the population who have a high level of matches to the entire User's Library as well as his Control Playlist increases the chances that users are found whose tastes are similar to the user.

Fifth, The Population Skim Rates are selected; in this step skim rates are defined as the cut-off percentages or threshold numbers that determine how many of the top ranked people are selected for inclusion in the Peer Comparison Group. The exemplary embodiment illustrated in FIG. 2 identifies >96% as the cut-off percentage criterion, and so the peer comparison group includes seven playlists, three having every song or entertainment product identified in the user's control playlist, with the remaining lists having 99%, 98% (two) or 97% match percentages.

Sixth, the system may optionally employ a Bracketing Algorithm comprising a process of doing several tests with various skim rates and averaging the results to ensure statistical relevancy.

Seventh, within the Peer Comparison Group, the system skims off the songs that match the user's Control Playlist, and creates “Peers' Non-Similar Lists” from the songs left in the Peer Comparison Group's libraries. The Peers' Non-Similar Lists each comprise a list of all the songs in the Peer Comparison Group list that are not in the User's Control Playlist or the User's unused playlist, which together comprise the user's Library.

Eighth, the Peers' Non-Similar Lists are compared to the subject user's Unused Playlist or Library to permit identification of songs that should not be suggested. This may be referred to as pasteurizing the Peers' Non-Similar Lists—In order not to suggest songs that the user already owns, the system audits the Peers' Non-Similar Lists for songs that exist in the user's entire User Library and filters them out of the Peers' Non-Similar Lists.

Ninth, the Peers' Non-Similar Lists are compared with one another to find song matches among this group. The songs that are most often cited or most common among the Peers' Non-Similars are identified as Peers' Popular Non-Similars.

Tenth, the Peer's Popular Non-Similars are ranked in order of number or percentage (%) matched, where songs that show up in more frequently in Peer Non-Similar lists are ranked higher.

Eleventh, either by system-designated Bracketing Algorithm, or by user designation, the system selects or “skims off” the top percentage of Popular Peer Non-Similar songs and identifies or designates them as Best Predictions. The relevancy rate that determines Best Predictions is called the Peers' Popular Non-Similar Song Skim Rate.

Twelfth, the best predictions are filtered. The system optionally allows the subject user to define filters that focus the resulting Best Predictions by categories or keywords. This enables users to receive results that fall within certain categories such as Genre, Year, BPM, or results containing keywords in the song titles, albums, composers, etc.

Thirteenth, a report is generated identifying the best prediction. In a plain language description of a search, a subject user asks for the predictions by requesting the process in a plain English query; for example, a user may input the following request: “Of all the people in the System Population who had ≧99% song matches (Population Skim Rate) to my Control Playlist (aka: my Peer Comparison Group), find me the songs that appear the most among their libraries but do not currently exist in my entire library (Best Predictions), then filter those results to contain only songs within the genres of: Rock, Southern Rock, Metal, Disco, and Easy Listening (Output Filter), and present me with the resulting list.”

The system may also have bracketing algorithms to sort entries into groups of more manageable size. For example, In any given session, there is potential for large variations in the number of entries (e.g., songs) in a given control list or user library, the size of the population involved and the number of matches found. To address the question of what percentage, or what number of users should be selected for the Peer Group when they are ranked, and what percentage or what number of songs should be selected as Popular Non-Similars, the system optionally employs a Bracketing Algorithm to determine the best number. When the bracketing algorithm is employed, the system runs a series of “samples” or tests covering a spectrum of variations to adequately address these broad possibilities. Common results or averaging from these “samples” could point to better theoretical matches. In other words—to optimize performance, the system should run a series of samples and use the “averaged” results. This is similar in principal to bracketing an exposure in professional photography—shoot one where it should be, then do one with a slightly larger f-stop, and one with a slightly smaller f-stop—to make ensure getting a picture with the optimal exposure. A repetitive, Monte-Carlo style, iteration may be employed to generate the averaged results.

Other applications are suitable for the system and method of the present invention. With access to other lists in a population, this system and method is readily used to suggest/predict preferences of products or services other than music, those products or services may include:
Consumer Products (e-Commerce applications)
films (On-Demand Video Rentals)
TV shows (Tivo® service)
books
games
or other items where the user has a history of consumption of multiple varieties of products within a category.

The system and method of the present invention also allows individuals to upload multiple product categories of preference lists that can be part of the preference equation as a cross-reference. Categories can include:
a. Music favorites list
b. Food product list (e.g., by store keeping unit/sku)
c. Movie/film list
d. Books
e. Etc.
f. Example Query: Of all the people who have the same Disco Music tastes as me, the System can suggest:
   i. Music in any genre
   ii. Disco music
   iii. Any movies
   iv. Romance novels (if the corresponding lists existed)

Cross-referencing could be applied where music lists could be input to determine preferences in other categories and vice versa. This can have a powerful effect for personalizing marketing and advertising messages to consumers.

Music lists are usefully characterized as a “Musical DNA” to determine the right music or correlated messages for advertising.

A PC/Online Application embodying this system and method preferably has the following capabilities:
Automatically Searches for music files on a subject user's computer
Accepts exported playlists from popular MP3 player applications
Creates an anonymous submission playlist text file of the user to protect privacy
Enables User to upload a playlist to central online database.
Enables Users who submit requests automatically have their music libraries become part of the System Population.

In another embodiment, a collaboration engine is available for creative users who have generated a creative work and wish to have others access the work and add collaboratively to the work. In an illustrative embodiment, artists may upload recordings for sale over the web. Such recordings may be recommended to a given user using the preference engine method given above. The uploaded recordings may be unfinished or incomplete recordings, with or without annotations, having one or more tracks of unaccompanied instrumental music or acapella singing recorded for later use in a multi-track format where others may choose to listen to the uploaded recording.

In accordance with the present invention, artists also have the option of allowing “collaboration” with other artists by posting individual tracks or combinations of mixes. Artists can solicit collaborations as well, for instance, if a subject artist believes she or he has a great song but is looking for someone other than her or himself to sing it, she or he could make the song available as a “collaboration” download with the vocal left off. The subject artist may offer to give up a percentage of the royalties for a finished collaborative piece that would be sold on the site. A collaborating artist could download it for a minimum fee, sing a vocal track on it and then list it back on the site as a collaborative piece—where both artists share in the revenues.

It will be appreciated by those of skill in the art that the method and system of the present invention provide a predictive method to simplify a user's search for new entertainment products or services (e.g., music) from the vast universe of possible choices.

Having described preferred embodiments of a new and improved method, it is believed that other modifications, variations and changes will be suggested to those skilled in the art in view of the teachings set forth herein. It is therefore to be understood that all such variations, modifications and changes are believed to fall within the scope of the present invention as set forth in the appended claims.

1. A predictive method for a subject user or consumer to identify new entertainment products or services from a plurality of possible choices, comprising the method steps of:
(a) assembling a control list having a selected plurality of entries identifying representative entertainment products or services for said subject user;
(b) identifying a peer comparison group for said subject user;
(c) comparing said subject user's control list of representative entertainment products or services with a selected number of control lists for a selected population of other user's to generate a peer comparison group having a selected number of matching control list entries;
(d) identifying non-similar entries from said peer comparison group's control lists;
(e) sorting said non-similar entries from said peer comparison group's control lists to generate a list of entries corresponding to best predictions for new entertainment products or services not yet identified with said subject user;
(f) selecting at least one entry from said list of entries corresponding to best predictions for new entertainment products or services not yet identified with said subject user: and
(g) reporting said at least one entry to said subject user.

2. The predictive method of claim 1, wherein step (b), identifying a peer comparison group for said subject user, comprises:
(a1) selecting statistically relevant number of users for selection as peers for said subject user from a system population comprising a plurality of user control lists;
(a2) identifying a selected number of song matches between said subject user and the rest of the users in said system population to select a statistically relevant peer comparison group of users who like a selected minimum number of the same entries; and
(a3) selecting users for the peer comparison group having at least said minimum number of the same entries.

3. The predictive method of claim 1, wherein step (d), identifying non-similar entries from said peer comparison group's control lists, further comprises:
(d1) identifying entries in the Peer Group lists that are not in the user's control list of entries to generate a peer non-similar list for each list in the comparison group; and
(d2) identifying the most often occurring or popular entries among the peers' non-similar lists.

4. The predictive method of claim 1, wherein the method is executed in a web-based transaction session and step (g), reporting said at least one entry corresponding to a best prediction to said subject user, comprises:
providing session results as recommended entertainment products or services to the subject user.
